(19) United States
(12) Patent Application Publication
(10) Pub. No.: US 2010/0318538 A1
(43) Pub. Date: Dec. 16, 2010

(54) PREDICTIVE SEARCHING AND ASSOCIATED CACHE MANAGEMENT

(75) Inventors: Robert M. Wyman, New York, NY (US); Trevor Strohman, Sunnyvale, CA (US); Paul Haahr, San Francisco, CA (US); Laramie Leavitt, Kirkland, WA (US); John Sarapata, New York, NY (US)

Correspondence Address: BRAKE HUGHES BELLERMANN LLP;c/o CPA Global, PO Box 52050, Minneapolis, MN, 55402, US

(73) Assignee: Google Inc., Mountain View, CA (US)

(21) Appl. No.: 12/484,171

(22) Filed: Jun. 12, 2009

(51) Int. Cl. G06F 17/30

(52) U.S. Cl. 707/759; 707/769

(57) ABSTRACT

A computer system including instructions stored on a computer-readable medium, may include a query manager configured to manage a query corpus including at least one predictive query, and a document manager configured to receive a plurality of documents from at least one document source, and configured to manage a document corpus including at least one document obtained from the at least one document source. The computer system also may include a predictive result manager configured to associate the at least one document with the at least one predictive query to obtain a predictive search result, and configured to update a predictive cache using the predictive search result, and may include a search engine configured to access the predictive cache to associate a received query with the predictive search result, and configured to provide the predictive search result as a search result of the received query, the search result including the at least one document.

### TECHNICAL FIELD

This description relates to searching on a computer network.

### BACKGROUND

Search engines exist which attempt to provide users with fast, accurate, and timely search results. For example, such search engines may gather information and then index the gathered information. Upon a subsequent receipt of a query from a user, the search engine may access the indexed information to determine particular portions of the information that are deemed to most closely match the corresponding query. Such search engines may be referred to as retrospective search engines, because they provide search results using information obtained before the corresponding query is received.

Other search engines may be referred to as prospective search engines, which provide search results to a user based on information that is obtained after a query of is received. For example, a user may submit a query that is stored by the prospective search engine. Later, the prospective search engine may receive information that may be pertinent to the stored query, whereupon the search engine may provide the received/pertinent information to the user. For example, the query may act as a request to subscribe to certain information, and the prospective search engine acts to publish such matching information to the user when available, based on the subscribing query.

In retrospective search engines, a cache may be used to store search results related to a particular query. Then, if the same or similar query is received again later, the stored search result may be provided at that time. Although the use of such a cache may improve a response time of a search engine, there still exists a need for search engines which provide faster, more accurate, and more timely results, and which do so in a way that most efficiently manages available computing resources.

### SUMMARY

According to one general embodiment, a computer system including instructions stored on a computer-readable medium, may include a query manager configured to manage a query corpus including at least one predictive query, and a document manager configured to receive a plurality of documents from at least one document source, and configured to manage a document corpus including at least one document obtained from the at least one document source. The computer system also may include a predictive result manager configured to associate the at least one document with the at least one predictive query to obtain a predictive search result, and configured to update a predictive cache using the predictive search result, and may include a search engine configured to access the predictive cache to associate a received query with the predictive search result, and configured to provide the predictive search result as a search result of the received query, the search result including the at least one document.

According to another general aspect, a computer-implemented method in which at least one processor implements operation including at least determining at least one document from a document corpus, determining at least one predictive query from a query corpus, associating the at least one document with the at least one predictive query, storing the at least one document and the least one predictive query together as a predictive search result in a predictive cache, receiving, after the storing, a received query, determining the predictive search result from the predictive cache, based on the received query, and providing the at least one document from the predictive cache.

According to another general aspect, a computer program product for handling transaction information, may be tangibly embodied on a computer-readable medium and may include executable code that, when executed, is configured to cause a data processing apparatus to predict at least one received query anticipated to be received at a search engine, store the at least one predictive query in association with a score threshold, receive a stream of documents over time, in conjunction with receipt of the stream of documents at the search engine, index the documents, perform a comparison of each document to the at least one predictive query, using the index, assign a score to each comparison, rank the comparisons based on each score, select comparisons from the ranked comparisons having scores above the score threshold, store the selected comparisons within a predictive cache, each selected comparison being associated with a score of the selected comparison, the corresponding compared document, and the at least one predictive query, receive the at least one received query at the search engine, and provide at least one document of the selected comparisons from the predictive cache. The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for predictive searching and associated cache management.

FIG. 2 is a flowchart illustrating example operations of the system of FIG. 1.

FIG. 3 is a block diagram showing more detailed examples of elements of the system of FIG. 1.

FIG. 4 is a flowchart illustrating additional example operations of the systems of FIGS. 1 and 3.

FIG. 5 is a block diagram showing example or representative computing devices and associated elements that may be used to implement the systems of FIGS. 1 and 3.

### DETAILED DESCRIPTION

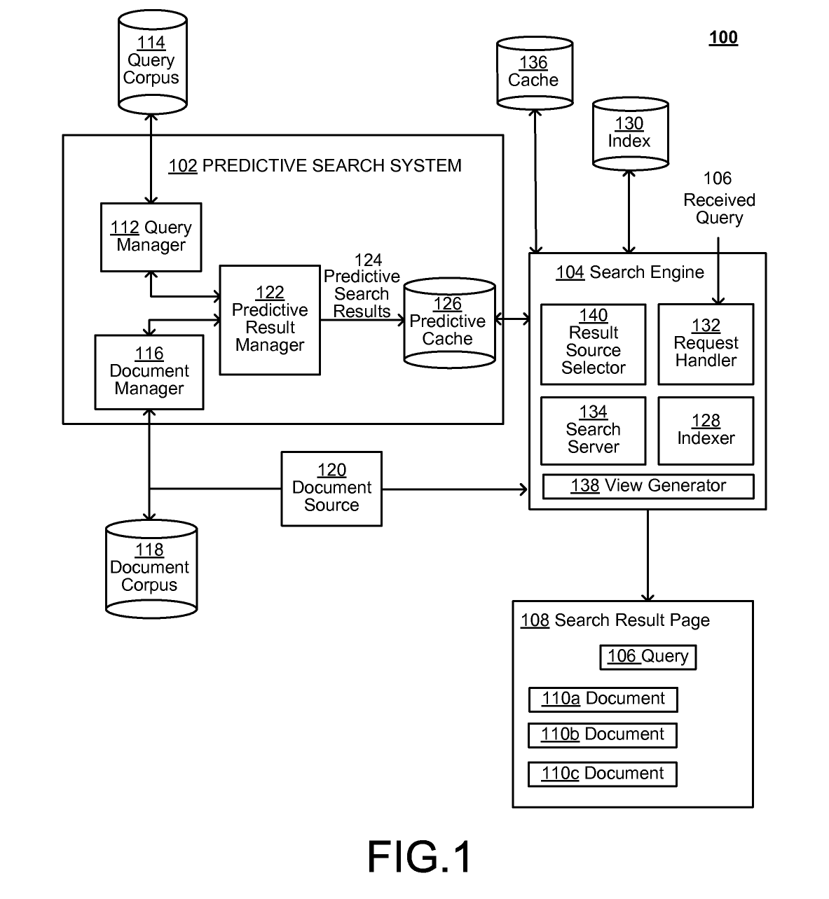

FIG. 1 is a block diagram of a system 100 for predictive searching and associated cache management. The system 100 may be used, for example, to predict future queries that may be received, and to pre-compute search results based thereon. Consequently, if and when a query that matches one or more of the pre-computed results is received from a user in the future, then appropriate ones of the pre-computed results may be returned for the received query. In this way, for example, users may be provided with faster, more accurate, and more timely results. Further, a provider of the system 100 may be enabled to implement a more efficient use of computing resources as compared to conventional search systems. In still further example implementations, the system 100 may be used to implement or supplement a number of applications that would be difficult or impossible for traditional search systems to implement, as described in more detail below.

In the example of FIG. 1, a predictive search system 102 that may be used in the system 100 to provide many of the features described above, as well as other features not specifically mentioned, is illustrated in conjunction with a search engine 104. Except as described below, the search engine 104 may be considered to represent, for example, virtually any traditional search engine(s) that is used to receive queries, such as a received query 106, and to output a search results page 108 including example documents 110a, 110b, 110c. For example, the search engine 104 may be a public search engine available over the Internet, so that the search result page 108 may represent a webpage in a particular browser (or otherwise using a graphical user interface (GUI)) that is made available to a user. To name but another example, the search engine 104 also may be provided over a private intranet, such as a company-wide intranet available only to certain employees or partners of a particular company.

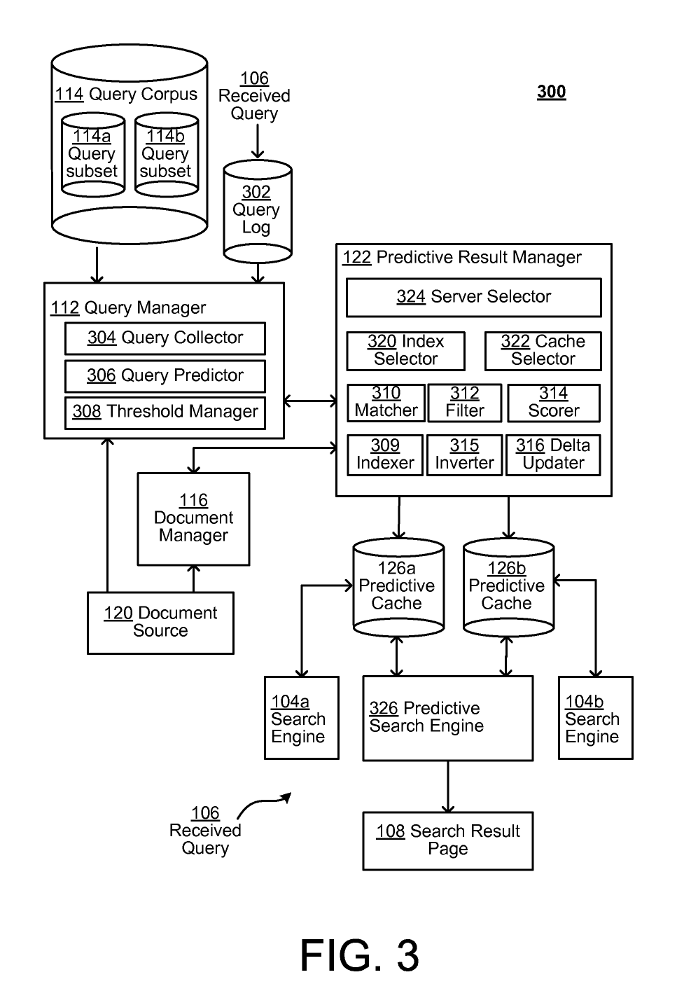

In FIG. 1, a query manager 112 may be configured to manage a plurality of predictive queries that are stored in a query corpus 114. That is, for example, each one of such predictive queries may be associated with a speculation, guess, expectation, or other belief that a same, similar, or otherwise corresponding query may be received. That is, such a predictive query may represent a query that is calculated or otherwise determined to occur at a future time. The query manager 112 may determine the predictive queries using one or more of a number of query sources. To name a few examples, the query manager 112 may determine the predictive queries based on queries anticipated by an owner/operator of the system 100, or based on a query log of previously-received queries, or based on a subject matter or other content to be searched using the predictive queries. These and other examples are discussed in greater detail, below, e.g., with respect to FIG. 3.

Meanwhile, a document manager 116 may be used to manage a plurality of documents in a document corpus 118. In general, such documents may be obtained from at least one document source 120. In this context, it may be appreciated that the term document may refer to virtually any discrete information that may be made available by way of the system 100. Such information may include, to name but a few non-limiting examples, articles, blog entries, books, or websites. The documents may include text, images, audio, video, or virtually any other available format. Consequently, the document source 120 may represent virtually any information source that is available to the network(s) on which the system 100 operates. Again, to name but a few examples, such sources may include blogs, remote subscription service(s) (RSS), news organizations, or any person or organization(s) publishing information onto the network of the system 100.

It should be appreciated that the document source 120 may produce documents over a given time period. A number, type, or content of the document(s) may change over time, and may be associated with either a relatively fast or relatively slow rate of change. For example, a document source regarding the stock market may produce widely-varying documents having content which changes quite rapidly over the course of a day or other time period. On the other hand, another document source may produce a document regarding a historical figure or event, and such a document may not change at all for a relatively long period of time.

At a given point in time, a predictive result manager 122 may be configured to input predictive queries and documents, and to compute predictive search results 124 therewith, which may then be stored in a predictive cache 126. In other words, for documents in the document corpus 118, the predictive queries in the query corpus 114 represent best guesses as to the type of queries that will be received by the search engine 104. Consequently, the predictive search results 124 stored in the predictive cache 126 represent results that would be needed by the search engine 104 should the later-received query 106 match or otherwise correspond to one or more of the predictive queries, so that the predictive search results 124 otherwise would have had to have been computed by the search engine 104 after receipt of the received query 106. In other words, instead of waiting to receive the received query 106 to formulate search results for the search results page 108, the predictive search system 102 preemptively and prospectively determine at least some of the search results page 108 (e.g., at least one of the documents 110a, 110b, 110c).

In contrast to many conventional prospective search systems (in which it is known that some user wishes results regarding a particular query, and thereafter receives those results when the results become available), the predictive search system 102 runs a risk that the predictive queries will rarely or never match the received query 106. In such a case, work performed to prepare the predictive cache 126 may not provide significant, or any, performance improvement of the system 100 as a whole. On the other hand, when the predictive queries more closely match or otherwise correspond to the received query 106, then significant advantages may result in implementing the system 100 as compared to conventional systems.

For example, the search engine 104 may operate using an indexer 128. That is, the indexer 128 may input documents from the document source 120, and may index contents of the documents to facilitate efficient searching thereof. In general, it may be appreciated that the search engine 104 may include many examples of conventional search engine elements that would be apparent to one of ordinary skill in the art, and that are therefore not described here in detail. In particular, for example, many types of indexers are known in the art, and any such conventional or available indexer may similarly be used in the system 100 (in either the search engine 104, or in the predictive search system 102, as described in more detail below). For example, the indexer 128 may be used to determine certain words or phrases within the documents, or certain topics, or characteristics of the documents such as date of publication or format, or a source of the documents in question. Many other types of data and metadata regarding the documents may be determined and indexed, as may be appreciated.

The documents may then be stored in an index 130 for later retrieval in use, for example, in formulating responses to the received query 106, when necessary or desired. As such, the documents may be indexed in a manner that facilitates determining such search results in an optimal or desired manner, such as by arranging the index 130 based on how recently the documents were produced and/or received, or by how often particular documents are accessed or used in preparing the search results page 108.

In practice, when the received query is received at a request handler 132, which may represent any conventional or available element(s) associated with managing received queries, the request handler 132 and/or a search server 134 may be used to formulate search results for the search results page 108. For example, the search server 134 may match terms or other elements of the received query 106 against the index 130 to obtain a list of documents that might possibly satisfy the receive query 106. Then, documents in the list of matching documents may be scored using known scoring techniques to obtain a ranked or scored list of documents, the highest-scoring of which may then be presented in order on the search results page 108.

The techniques of receiving queries at a request handler, matching the received queries against an index of documents, and then scoring or otherwise filtering the matching documents to obtain a ranked list of documents for compiling a search results page, and similar and ancillary or related techniques, are generally known. One difficulty with using such techniques, by themselves, is that a large amount of intensive processing (e.g., matching the query 106 against the index and scoring the matched documents) is executed after receipt of the received query 106. Additionally, the indexing itself occurs over time, and may need to occur just before the query 106 is received if the best and most up-to-date results are to be provided. Meanwhile, users wish to receive results as soon as possible, and within a time window after which the user will generally quit waiting for results. Consequently, for example, the search server 134 may only have enough time to match the receive query 106 against a portion of the index, and/or may only have enough time to score a portion of the matched documents, before a pre-determined time limit is exhausted. If the best (i.e., best-matched and highest-scoring) documents are not indexed, matched, or scored before this time limit is reached, then the user may not receive the best available search results.

A related difficulty is that the search engine 104 may frequently have to re-index, re-match, and/or re-score documents over time in order to provide the best results. For example, even an unchanging document (such as the example document above regarding an historical figure or event) may periodically be re-processed relative to other documents. Additionally, when the search engine 104 is executed on a distributed basis, e.g., at a number of different datacenters, then each such datacenter may need to perform some or all of the described search processing in order to provide good, fast, and timely results.

One technique that traditional search systems use to make the search process faster, more efficient, and generally better, is to implement a traditional cache 136. Many such types of traditional caches are known, and are not discussed here in detail. In general, though, such a cache may serve to store search results from the received query 106, so that if the same or similar query is received again later, the cached search results may be provided from the cache 136, without having to return to the index 130 nor to execute, in full, the matching/scoring processes and related processes as just described.

Many cache management techniques are known, which generally may be based on various trade-offs associated with the use of the cache 136. In this regard, for example, it may be appreciated that inasmuch as the cache 136 stores previously-calculated results, the cache 136 may become stale over time, that is, may include old or out-dated documents, or documents having old or outdated indexing/matching/scoring thereof. In other words, the user gets the advantage of receiving search results relatively quickly from the cache 136, but this advantage may become negligible or non-existent if the cached results are out-of-date and the user therefore misses the best-available document(s) that was otherwise available in the index 130 (but that would take a longer time and increased computing resources to retrieve).

Therefore, in various cache-management techniques, it may be desirable to obtain a high “hit-rate” for the cache, meaning that there is a high likelihood that the received query 106 may be responded to using contents of the cache 136. At the same time, techniques exist to phase-out and/or replace contents of the cache 130 in a timely manner, so that the cache 130 does not become stale and continues to provide useful results.

Using the various techniques described herein, then, the search engine 104 may output the search result page 108. More specifically, a view generator 138 may be used to output the search results page in a format and manner that is usable and compatible with whatever browser or other display technique is being used by the user. The view generator 138 also may be responsible for various known ancillary functions, such as providing, for each document 110a, 110b, 110c, a title or representative portion (sometimes called a “snippet”) of the document(s), in conjunction with a link to that document.

As described herein, the predictive search system 102 may be used, for example, to supplement or enhance an operation of the search engine 104. For example, the predictive cache 126 may be used to replace, supplement, or enhance the cache 136, in order to provide a desired result. In this context, a result source selector 140 may be included with the search engine 104 that is configured to select between the predictive cache 126, the cache 136, and the index 130. For example, the result source selector 140 may be configured, in response to receipt of the received query 106, to access the predictive cache 126 first, and then to access the cache 136 if the predictive cache 126 does not contain a suitable or sufficient result, and then to access/use the index 130 if the cache 136 does not provide a suitable or sufficient result. In other examples, the result source selector 140 may implement a more complicated access scheme, such as, for example, accessing both the predictive cache 126 and the cache 136 and determining a best result from both caches based on such accessing. In this way, the various advantages of the predictive cache 126, cache 136, and index 130 may be used to their respective best advantage(s).

For example, it may be appreciated that the predictive search results 124 may be calculated by the predictive result manager 122 prior to receipt of the received query 106. Therefore, the predictive result manager 122 may perform any necessary indexing, matching, and scoring of documents from the document corpus 118 with respect to the predictive queries from the query corpus 114, without the same concern for the above-referenced time limitations experienced by the search engine 104. Consequently, the predictive result manager 122 may be able to process more or all available documents as compared to the indexer 128 and the search server 134, and, consequently, the search results in the predictive cache 126 may be superior to the results in the cache 136 or to results obtained using the index 130.

In additional or alternative implementations, it may be appreciated that the predictive result manager 122 may continually or periodically update the predictive cache 126, again without waiting for the received query 106. Since new documents may have arrived at the document corpus 118 since a previous update of the predictive cache 126, the result is that the predictive cache 126 remains updated with the most recent documents, so that the predictive cache 126 remains relatively fresh relative to the cache 136.

On the other hand, as referenced above, some documents may change or otherwise need to be updated relatively infrequently. In the predictive search system 102, such unchanging documents only need to be processed once (or very infrequently) for placement in the predictive cache 126, where they may stay essentially indefinitely to be available for responding to the received query 106, without needing to be reprocessed or replaced, thereby saving computing resources in comparison to conventional search systems. In many search systems, given a distribution of a large number of documents, it may occur that documents at or near a peak of the document distribution may change relatively rapidly, while documents within a tail of the distribution change infrequently. Although an absolute number of documents at a given point in the distribution tail may be relatively small, a distribution with a long enough tail may nonetheless represent, in aggregate, a large number of documents. Consequently, by removing or reducing a need to process (and reprocess) these documents, significant computing resources may be conserved for processing more rapidly-changing documents.

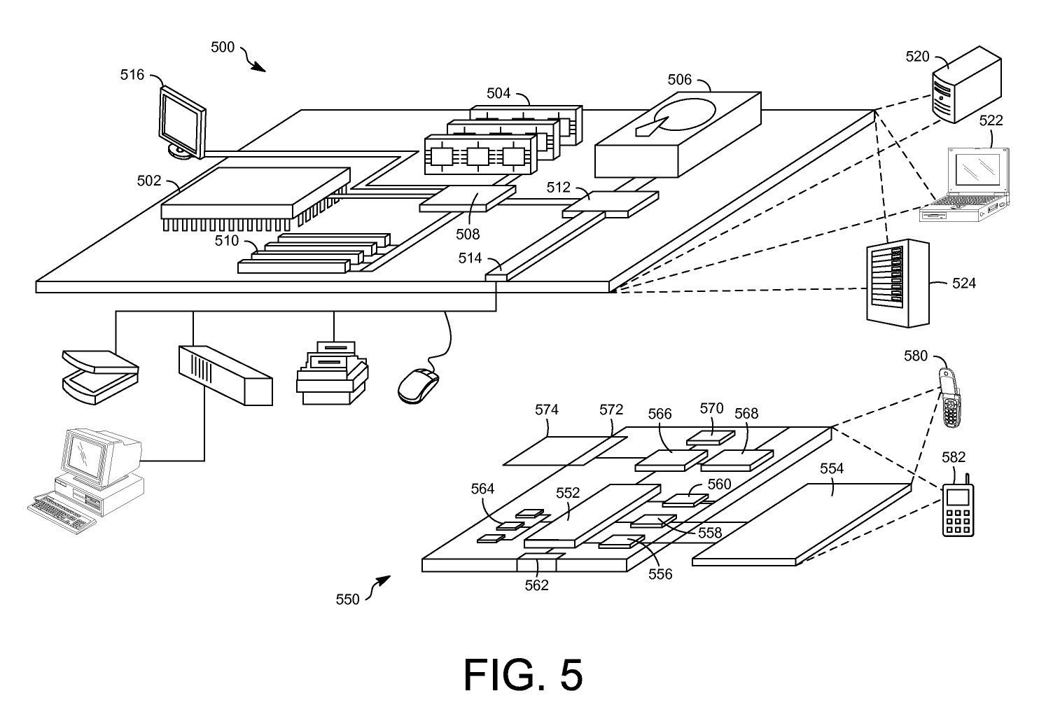

As referenced in more detail with respect to FIG. 5, below, the predictive search system 102 and the search engine 104 may be implemented using, for example, any conventional or available computing resources. Of course, such computing recourses would be understood to include associated processors, memory (e.g., Random Access Memory (RAM) or flash memory), I/O devices, and other related computer hardware and software that would be understood by one of ordinary skill in the art to be useful or necessary to implement the system 100.

In many cases, the system 100 may be understood to be implemented over a wide geographical area, using associated distributed computing resources. In such cases, it will be appreciated that certain elements or aspects of the system 100 may be wholly or partially implemented using physically-separated computing resources. For example, a memory illustrated as a single element in FIG. 1 may in fact represent a plurality of distributed memories that each contain a portion of the information that is described as being stored in the corresponding single memory of FIG. 1. Therefore, it may be necessary or preferred to use associated techniques for implementing and optimizing the partitioning and distributing of stored information among the plurality of memories. Similarly, although a single search server 134 is shown, it should be appreciated that serving resources may also include a plurality of distributed computing resources. Notwithstanding example implementations such as those just described, and other example implementations in which elements of the system 100 may be distributed, the system 100 is generally illustrated and described in the singular, with singular elements for each described structure and/or function, for the sake of brevity, clarity, and convenience.

Additionally, although elements of FIG. 1 are shown separately as just referenced, it should be appreciated that each element of FIG. 1 also may represent, or include, more than one element to perform the described functions. For example, the search server 134 may represent a first server for serving results using the index 130, and a second server as a cache server for serving results from the cache 136.

It should be apparent that the system 100 may be in communication with an external user. That is, in some cases the system 100 may be provided, implemented, and used by a single entity, such as a company providing an intranet in the examples above. In other examples, the system 100 may be provided as a service to public or other external users, in which case, for example, the received query 106 and/or the search result page 108 may be exchanged with such an external user who may be using his or her own personal computing resources (e.g., a personal computer and associated monitor or other viewscreen for viewing the search result page 108).

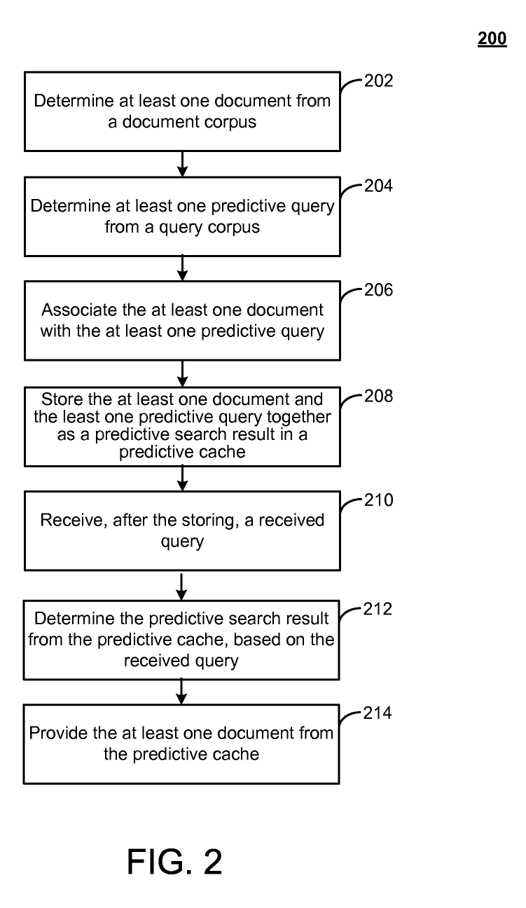

FIG. 2 is a flowchart 200 illustrating example operations of the system of FIG. 1. It should be appreciated that the operations of FIG. 2, although shown sequentially, are not necessarily required to occur in the illustrated order, unless specified otherwise. Also, although shown as separate operations, two or more of the operations may occur in a parallel, simultaneous, or overlapping fashion.

In FIG. 2, at least one document may be determined from a document corpus (202). For example, the document manager 116 may determine a document from the document corpus. As described above, the document manager 116 may represent conventional hardware/software for receiving and/or obtaining documents from an external source. The document manager 116 may receive the documents directly from the document source 120 and then store the documents in the document corpus 118, or may first store the documents in the document corpus 118 and then read the documents therefrom. The document manager 116 may check the document corpus 118 periodically and then batch process a group of documents at once, or may read documents as they arrive.

At least one predictive query may be determined from a query corpus (204). For example, the query manager 112 may obtain one or more predictive queries from the query corpus 114. As with the document manager 116, the query manager 112 may generally represent known hardware/software for reading from the query corpus 114. Also as with the document manager 116, the query manager 112 may include functionality associated with obtaining the predictive queries in the first place, e.g., from a query log of past queries, or based on inspection of the documents in the document corpus 118, or by other techniques as described in more detail with respect to FIG. 3.

The at least one document may then be associated with the at least one predictive query (206). For example, the predictive result manager 122 may be configured to match the at least one document against some or all of the predictive queries. In this context, conventional indexing techniques may be used to index the documents in the document corpus, and to match the document against the predictive queries. However, it should be appreciated that in this context, each document is matched against the predictive queries, which is essentially an inverse operation of, e.g., the normal indexer 128/search server 134, inasmuch as those elements may generally operation to compare an incoming query against a plurality of documents to obtain corresponding search results.

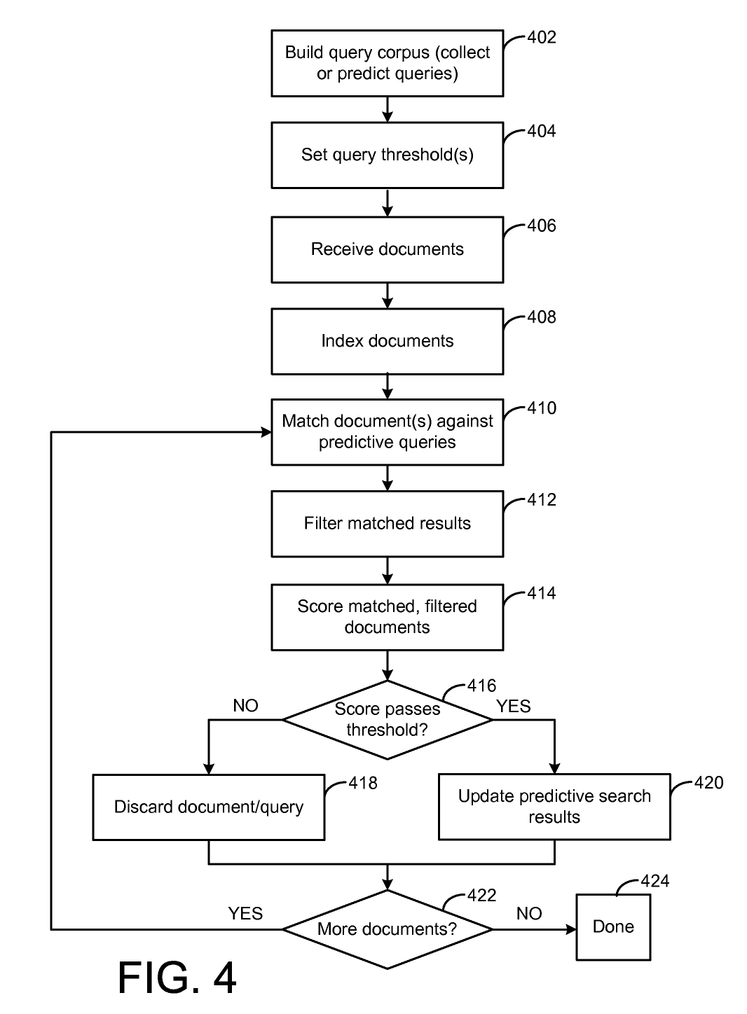

As described in detail with respect to FIGS. 3 and 4, the predictive result manager may be operable to perform an initial match of the document(s) with the predictive queries, e.g., a simple match of textual terms within the document(s) and the predictive queries. Such an operation may generally result in an overly large number of possible results. Consequently, additional filtering, ranking, and/or scoring may be applied to the matched results to attempt to identify the most relevant search results. For example, as described below, a query threshold may be associated with each predictive query, and then only queries having a score above the relevant threshold may be retained for storage in the predictive cache 126.

The at least one document and the least one query may thus be stored together as a predictive search result in a predictive cache (206). For example, the predictive result manager 122 may output the predictive search results 124. The predictive search results 124 may include or reference the document, the predictive query, and other information that may be desired for inclusion in the search result page 108. For example, in the latter regard, the title of the document may be included, or a portion of the document that expresses a summary of the document or that illustrates excerpts of the document including search terms of the predictive query (known as a snippet). Thus, for example, the predictive search results 124 may be expressed as a (document {query, score, snippet}) tuple, for storage as such in the predictive cache 126. Of course, FIG. 1 provides only some non-limiting example implementations. For example, there may not be a separate predictive cache from the cache 136; instead, for example, the predictive search results 124 may be applied directly to some or all of the cache 136. The predictive search results 124 may be output separately/individually, or may be packaged and grouped together to update distributed cache(s) on a batch basis.

After the storing, a received query may be received (210). For example, the received query 106 may be received by way of the search engine 104. In another example, as described below with respect to FIG. 3, it is possible that the received query may be received directly at, or in association with, the predictive result manager 122.

The predictive search result may be determined from the predictive cache, based on the received query (212). For example, the search server 134 (which, as referenced above, may refer to or include an integral or separate cache server) may associate the received query 106 with a corresponding query of the predictive search result 124. In this regard, it should be appreciated that the received query 106 may be an exact match with a corresponding predictive query. In other implementations, the received query may correspond only partially or semantically with the predictive search result, and need not represent an exact query match. As referenced herein, the result source selector 140 may be instrumental in selecting one or more of the predictive cache 126 to satisfy the received query 106, as opposed to selecting, e.g., the cache 136 and/or direct query processing using the index 130, indexer 128,and search server 134.

The at least one document may be provided from the predictive cache (214). For example, the predictive cache 126 may output the at least one document from the predictive cache 126 to the search server 134 and/or the view generator 138, which may then be output thereby as some or all of the search result page 108. For example, the predictive search result 124 may provide the document 110a as part of the search result page, while the document 110b may be obtained from the cache 136 and the document 110c may be obtained using the index 130, indexer 128,and search server 134. Of course, in this regard, the documents 110a, 110b, and 110c are illustrated and described in the singular for brevity, but may represent larger sets of documents, not all of which will generally be illustrated on the (first page of) the search result page 108. Rather, as is known, whichever document(s) have the highest score or are otherwise judged to be the best result are generally displayed first/highest within the search result page 108.

Thus, as may be appreciated from the above discussion, the system 100 provides an example of the operations of the process 200, in which, for example, predictive queries may be matched, filtered, and scored against documents during an indexing process that occurs before the received query 106 is actually received. Then, in examples of large-scale, distributed search systems, the cached results (i.e., the predictive search results 124) may be pushed to datacenters along with index portions assigned to those datacenters. By precomputing predictive search results in these and related manners, a computational load on search server(s) 134 may be reduced. In addition, the predictive search results may be computed based on all of the available documents, resulting in better-quality search results. Further, the system 100 and related systems may offer improved logging of queries and associated search results. For example, the system 100 may track when the search result page 108 changes, e.g., as a result of newly-predicted predictive search results 124. Based on when and how such logged search result pages change, the system 100 may be able to discern errors in operation of the predictive search system 102 and/or the search system 104.

In the system 100, it may occur that some percentage of predictive queries in the query corpus 114 is rarely or never used, e.g., if no user (or few users) ever submits a corresponding query as the received query 106. In such cases, computing resources spent pre-computing predictive search results for such non-used queries may not be optimally deployed in that sense.

Nonetheless, the system 100 overall provides the possibility of increased efficiency of computing resources overall. For example, the predictive search results 124 generally need only be computed once, even for large-scale or worldwide search systems (assuming, e.g., that the document is not modified and/or that there is no new or modified indexing process that is deployed). Thus, a cost of query processing may be shifted to an index/match/filter/score phase, when no user is waiting for a result. In addition, for example, this may allow a choice of the time and location of obtaining a scored document. That is, the time and location may be selected, for example, based on where and when the scored document may obtained most cheaply in terms of, for example, time, money, and/or computing resources. Thus, even though such indexing/matching/filtering/scoring may take more time and machines/resources when compared directly to comparable indexing/scoring processes of conventional search engines, it may be appreciated that a net reduction of computing resources may occur, due to improvements associated with the system 100, such as, for example, a reduced number of cache misses in serving datacenters (due to the presence of the predictive search results therein).

More particularly, it may be appreciated that in conventional search systems, users may submit queries at a frequency of volume of their individual choosing. Moreover, such users are frequently motivated to submit queries at the same or similar times, such as at a time surrounding an event or occurrence about which users are curious. Thus, it is difficult or impossible to control a number of queries per second, so that operators of such conventional search engines are motivated to provision computing resources based on such high or peak query loads.

In contrast, the system 100 can and does control a rate at which documents are scored against some or all of the available predictive queries. Therefore, it is possible to provision for more even usage of computing resources. Further, if a necessary computational cycle for scoring the documents is less than desired latency of providing the predictive search results 124, then an operator of the system 100 may choose when to execute the scoring process(es), e.g., at a time such as late at night when a frequency of received queries and other need for the available computational resources is low.

FIG. 3 is a block diagram showing more detailed examples of elements of the system of FIG. 1. In FIG. 3, a system 300 is illustrated in which additional example operations of the query manager 112 and the predictive result manager 122 are illustrated in more detail. Also, example operations are illustrated in which the predictive result manager 122 operates in conjunction with multiple types of search servers, and/or operates independently of other search servers (e.g., such as may be found in conventional retrospective search engines).

For example, in FIG. 3, a query log 302 is illustrated that represents a log of, for example, queries received at the search engine 104 of FIG. 1 (not specifically illustrated as such in FIG. 3). Such a query log may represent a complete list of received queries, or may represent a filtered or selected list of queries that are thought to have particular likelihood to be received again in the future. In the latter regard, a query collector 304 of the query manager 112 may be configured to operate and/or read the query log 302, or other source of previously-used queries that have been determined for use as predictive queries. Then, the query manager 112 may update the query corpus 114 based on the determined queries.

The query log 302 also may be used for additional or alternative purposes. For example, the query log 302 may be used to change a time-to-live (TTL) of a entry in the cache(s) 126 and/or 136, so that, for example, more useful entries may be maintained longer, while less useful ones are deleted relatively earlier from the cache(s). More generally, the query log 302 may be used to determine statistics about stored queries, which may be used to manage the cache(s) 126/136. For example, it may occur that space in the cache(s) 126/136 is relatively limited, so that, e.g., an entry may only be stored for a maximum of two hours. If the query log 302 is used to determine that a particular query will only be accessed (on average) every four hours, then such a query may be immediately deleted. Similarly, but conversely, if a query will be accessed, on average, every hour, then that query may be maintained for a longer time within the cache(s) 126/136. In these and related ways, the query log 302 may be used to increase a likelihood of a cache hit during normal operations of the system(s) 100/300.

The query manager 112 also includes a query predictor 306. The query predictor 306 may be configured to speculate or guess as to what future received queries may be received from one or more users. Different techniques may be used to make such predictions. For example, the query predictor 306 may be provided with information about a topic or other area of interest, and may generate queries about the most common terms associated therewith.

Somewhat similarly, the query predictor 306 may predict queries based on incoming documents from the document source 120. For example, the query predictor 306 may analyze the incoming documents to determine particular terms, or very frequent terms contained therein, or terms associated with a particular designated topic of interest. For example, the query predictor 306 may be configured to parse the incoming documents, e.g., semantically, to determine names or other terms of potential interest.

When basing the predictive queries on incoming documents, where it is understood that the incoming documents may change over time, a result is that the contents of the query corpus 114 changes dynamically to reflect a most up-to-date content of the documents which is therefore most likely to be the subject of later-received queries. For example, if at a point in time a very news-worthy event occurs, such as an airline crash, a presidential election, or a final score of a football game, then as these events occur, new incoming documents will generally include terms related to the event(s) in question. Then, for example, by comparing terms in documents across a number of different documents, then the query predictor 306 may formulate new queries. For example, in the example mentioned above regarding an airline crash, the query predictor 306 may begin to observe a frequent occurrence of the relevant flight number, a location of the crash, or other relevant information. Then, the query predictor 306 may formulate predictive queries based on this information, which may then be used to re-compute the predictive search results for some or all of the query corpus 114.

It may be appreciated that determination of the predictive queries is an ingredient in maximizing a cache hit rate and freshness for the cache 126. In this sense, a query utility may be maximized, for example, based on computational cost of the query relative to how much the query will result in corresponding hits or misses at the predictive cache 126. Thus, a predictive query may include an exact match to the receive query, or, more generally, may include a minimum amount of data necessary to produce the correct score for a user request.

Further in FIG. 3, the query manager 112 is illustrated as including a threshold manager 308. As referenced herein, each query may be associated with a score threshold that is used to discard results below the threshold and to store results above the threshold. The threshold manager 308 may be configured to set a threshold for queries such that a sufficient number of queries is removed, without removing so many queries that the system 300 begins to lose useful search results.

In general, search terms that occur very frequently (e.g., that frequently match documents from the document source 120), such as a name of a very famous person, may require a high threshold in order to avoid an overwhelming number of results. On the other hand, less-frequent search terms, such as a name of a person who is not as famous, may require a low threshold in order to obtain very many results at all. In this way, a likelihood may be increased that the predictive search results 124 used to update the predictive cache 126 will actually result in corresponding changes to the search result page 108.

In order to determine a threshold, the threshold manager 308 may, for example, map determined scores across a sample of older documents within the document corpus 118. Then, based on an analysis of an extent of matching of the query to the older documents as expressed by the sample scores, the threshold manager 308 may determine thresholds relative to scores on these older documents.

In such examples, such thresholds may be considered to be relatively static thresholds, and may be determined primarily or exclusively on historical (i.e., already-received) documents. For example, a query related to a very famous person such as mentioned above, such as the President of the United States, may be set at a high level virtually indefinitely. More generally, such static thresholds may be scheduled to be re-set or re-determined at pre-determined intervals, which may be relatively frequent or infrequent.

In additional or alternative examples, the thresholds may be set in a more dynamic fashion, e.g., may used past and incoming documents, and may be learned over time and may change over time in a manner designed to provide search results that are optimized in terms of quantity, quality, and rate of return of results. For example, the threshold manager 308 may be configured to observe a frequency, or a change in frequency, with which individual queries within the query corpus 114 match content from the document source(s) 120 that are stored and/or as the documents arrive. If a query matches infrequently, such a query may be associated with a low minimum threshold. On the other hand, if a query matches frequently, the threshold may be increased to reduce the number of results per time period. If a rate of change of such matching changes over time, and particularly, within a short time period, then again the threshold manager 308 may increase or decrease the threshold score accordingly.

For example, as referenced above, a famous person may be associated with a relatively high threshold. If such a person becomes involved in a news story, then for a period of days afterwards, the threshold manager 308 may raise the threshold associated with related queries even higher. Then, after several days have passed and the news story no longer is receiving heightened coverage, the threshold manager 308 may gradually lower the associated threshold(s) back to their previous level (or other appropriate level).

Thus, the threshold manager 308 may rely on historical information concerning the rate of matching for a query, as well as the scores of previously matched items, as well as on current information about the rate of matching and/or a rate of change of the matching. In so doing, the threshold manager 308 may help to ensure that there is a more steady flow of results for any particular query. That is, for example, as matching rates for a query increase and decrease over time, the associated threshold will increase and decrease in synchronization therewith. Consequently, peaks and troughs in result flow may be reduced, and a rate of new result generation may be controlled and optimized so as to provide users with enough results to help ensure satisfaction of the user, but not so many results as to overwhelm either the user or the resources of system(s) 100/300.

In the systems 100 and 300, the query manager 112 may execute other functions not necessarily shown in detail in FIGS. 1 and 3. For example, it may be appreciated from the above that the queries in the query corpus 114 may be considered to have a lifetime or otherwise persist in the query corpus for a period of time. The query manager 112 may thus be responsible for maintaining a lifetime of the predictive queries; e.g., deciding whether, when, and how to remove or replace a predictive query that becomes outdated or no longer useful. While the predictive queries do exist within the query corpus 114, they may be matched and scored against all new incoming documents, as those documents arrive. Consequently, the predictive search results 124 may constantly be current and up-to-date so that the user submitting the received query 106 receives timely search results, even if the particular corresponding predictive query has been stored in the query corpus for a relatively long time.

Further in FIG. 3, the predictive result manager 122 may include an indexer 309, a matcher 310, a filter 312, and a scorer 314. As appreciated from the above, the indexer 309 may represent a generally conventional or known indexer to process the documents from the document source 120. The matcher 310 may thus be used to match the documents against the queries within the query corpus 114, which may result in a relatively large number of matches (e.g., situations in which documents contain at least one or some of the terms of a given predictive query).

As is known, such matches generally may provide but a gross or high-level similarity between documents and queries. For example, such matches may fail to distinguish between two persons having the same name, or between two words that are spelled the same but that have very different meanings, or may fail to notice that the matching document is one that is not referenced by any other document or website (and may therefore be considered not to be a very valuable document as a potential search result).

Thus, a filter 312 may be used to filter the matched documents and queries. Such filtering may occur at a level that removes a large majority of the matched documents that are very unlikely to provide useful results. For example, as just referenced, the filter 312 may remove documents which are not referenced by any other document or website, or may remove (filter) queries/documents based on other desired filtering criteria.

A scorer 314 may be used to score the remaining matched, filtered documents, using known scoring techniques. For example, such scoring may occur based again on the number of references to the document, or may occur based on semantic analysis of each document which may indicate a likelihood of a desired meaning of the matched terms (as opposed to alternate meanings of the same terms). Then, the above-referenced threshold may be applied to remove queries/documents below the relevant threshold. Such operations may occur using the scorer 314, the filter 312 or another filter (i.e., using the threshold as a filtering criteria), or using a separate threshold comparator.

From the present description, it may be appreciated that documents from the document source 120 may be compared against some or all of the queries of the query corpus 114. As a result, a single document may ultimately be scored against a plurality of queries. Such an arrangement of data is inverted from a typical result desired by a user, in which the user's single query is desired to be matched/scored relative to a plurality of documents. In this regard, then, an inverter 315 may be used to invert the format of the stored predictive search results from a single document related to multiple queries, into a format in which a single query is associated with a plurality of documents for return on the search result page 108.

Once the predictive search results 124 are determined, it may be time to update the predictive cache 126. In this regard, it should be appreciated that a delta updater may be used to update only the new changes that have occurred between the new predictive search results 124 and the predictive cache 126. For example, instead of updating all corresponding cache entries for the predictive search results, the delta updater 316 may simple notify the cache 126 that a particular entry needs to be deleted, or that another particular entry should be modified or replaced.

The predictive result manager 122 is further illustrated as including an index selector 320, a cache selector 324, and a server selector 326. Each of these selectors, and other possible selectors or related functionality not specifically mentioned here, may relate to a recognition that different requirements or characteristics may exist for certain ones or types of predictive queries, documents, predictive caches, or search servers. For example, different query sets 114a, 114b of the query corpus 114 may have different characteristics and/or be associated with different (types of) documents. Consequently, as explained in more detail hereinbelow, the system 300 may benefit from various types of optimizations, or may provide certain uses or functionality of a type and/or extent not available in conventional search engines.

For example, the index selector 320 may be used for index selection, e.g., to select between a plurality of indices and associated indexing techniques or characteristics. For example, a first index may be associated with a very slow indexing speed or high volume (and associated large amount of computing resources), while a second index may be associated with a relatively fasterindexing speed or low volume. In general, it may be appreciated, e.g., that using the higher speed index on a document that does not need such indexing (e.g., a rarely-used and/or small document) may not be a good use of resources. Conversely, attempting to use the second (e.g., slower) index for documents that require fast indexing may result in unsatisfactory performance characteristics.

Similarly, different indices may be associated with different search engines 104a, 104b (and associated search servers). Again, such servers may have different needs or requirements in terms of speed, volume, or other performance characteristic(s). Therefore, again, it may be advantageous to select between different indices to match available indexing operations to the needs of associated search engines/servers.

Thus, the index selector 320 may be used to determine which index is appropriate for a given indexing operation. For example, the index selector 320 may first consider a query set such as the query set 114a, which may represent queries from a certain time period or queries having some other common characteristic(s). By comparing a new document to the query set 114a associated with a certain time period, the index selector 320 may determine how many of the queries would have been satisfied by the new document within the time period. From this, if it is discovered that the new document would have served a large number of the queries of the query set 114a, then that document might be put by the index selector 320 into an example of the fast/high volume index referenced above. Then, on the other hand, if a low number of the queries would have been satisfied by the new document, then the document might be put into a slower index.

Somewhat analogously, and perhaps in conjunction with the index selector 320, a cache selector 322 may be used to select between multiple predictive caches 126a, 126b. For example, it may occur that the first query set 114a is associated with a first predictive cache 126a, while the second query set 114b is associated with a second predictive cache 126b. Similarly, the sever selector 324 may be used to select between first and second search engines/servers 104a/104b.

In general, the use of the cache selector 322 and/or the server selector 324 may be associated, again, with a recognition that the different query sets 114a, 114b (and their corresponding matched/filtered/scored documents) may be associated with, and useful for, different application areas. That is, it is possible to discern information characterizing certain ones of the predictive queries based on which documents they match (and score highly against), and vice-versa, to discern characteristics of the documents based on which queries they match (and score highly against). Using such discerned information, the system 300 maybe used to execute certain applications that may be uncommon or unavailable in traditional search engines.

For example, documents from the document source 120 that match the query set 114a may be determined to include a large amount of spam or other commercial or unwanted documents. In another example, documents matching the query set 114b may be determined to have some other characteristic, such as being very recent in time. Thus, some applications of the system 300 include a use as a spam detector, or as a detector of documents having some other known characteristics.

Additional applications may be implemented differently depending on desired characteristics of the applications. For example, applications which have a high update rate may require high cache hit rates, low index latency, and a high degree of freshness of results of the associated cache, in the sense described above. Consequently, the some or all of selectors 320, 322, 324 may perform respective selections accordingly.

In other example applications, the system 300 may operate as a back-end service for providing multiple types of search results. For example, inasmuch as it is relatively fast and inexpensive to serve queries from a cache such as the predictive cache 126, it may be possible to use multiple predictive caches 126a, 126b to provide such varying results simultaneously. For example, such varying results may include text-based document results, video-based document results, or other varying formats or types of document results. For example, a query about the weather may very quickly return a local weather map, a 5 day forecast, top news stories about the weather, and other useful information, all returned from one or more of a plurality of predictive caches. Somewhat similarly, such back-end support may enable an otherwise conventional search engine to provide the type of near-instantaneous results that may otherwise be difficult, expensive, or impossible for such a search engine to provide, such as spelling correction or query suggestion(s) (e.g., auto-complete).

Other application areas are also contemplated, although not necessarily discussed herein in detail. For example, the system 300 may be used to test different scoring techniques, e.g., by testing different scorers on the same query set, and then correcting scores when necessary or desired. Many other application areas also may be implemented using the system 300, as would be apparent.

The system 100 above is described as working in conjunction with the search engine 104, and the system 300 is illustrated as operating in conjunction with the search engines 104a, 104b. In such cases, and as shown explicitly in FIG. 1, the document manager 116 and the respective search engine(s) may receive the same documents from the same document source(s) 120.

It may be appreciated, however, that it is not necessary for the predictive search system 102 to operate in conjunction with a retrospective search engine or any conventional search engine. For example, the predictive search system 102 may operate in conjunction with a predictive search engine 326, which, although not specifically illustrated, should be understood to include similar elements as the search engines 104, 104a, 104b, such as, e.g., a request handler, view generator, and search (e.g., cache) server.

In such a case, upon receipt of the received query 106, the predictive search engine 326 may immediately provide a corresponding predictive result from one or more of the predictive cache(s) 126a, 126b. In such embodiments, if the received query does not match any of the predictive queries for which the predictive search results were pre-calculated, then the predictive search engine 326 may be unable to provide results, or may at that time need to access a separate search engine to provide search results.

FIG. 4 is a flowchart 400 illustrating additional example operations of the systems of FIGS. 1 and 3. In the example of FIG. 4, as may be appreciated from the above description, the query manager 112 may be used to build the query corpus 114 (402). As already described, for example, the query collector 304 may collect a subset of queries from the query log 302, and/or the query predictor 306 may be configured to predict the queries in the manner(s) describe above, or in other ways, as may be apparent or available.

The threshold manager 308 may then set the threshold for each of the predictive queries (404). In some implementations, a query may have a different threshold depending on which query set 114a, 114b the query is included in, or depending on which predictive cache 126a, 126b or search engine 104a, 104b is the ultimate destination of the predictive query in question.

Documents may be received by the document manager 116 from the document source(s) 120 (406). Then, the documents may be indexed (408). For example, the index selector 320 may select the index 309, or may select another index (not specifically shown in FIG. 3), in order to index the received document, such as when, as above it is determined that the document in question requires a high speed, high volume processing.

Then, the matcher 310 may be used, for example, to match each document against each corresponding query (410). The filter 312 may then filter the remaining, matched queries (412) before scoring the matched, filtered documents and queries (414). Then, if the score does not pass the determined query threshold score as described above (416), the document and/or query may be deleted or may otherwise be discarded or non-used (418). Conversely, if the score does pass the query threshold (416), then the contents of one or more of the predictive caches 126a, 126b may be updated accordingly (420).

If more documents exist (422), then the process may continue for remaining documents that have yet to be matched/filtered/scored. Otherwise, the process ends (424).

Thus, it may be seen that the systems 100 and 300 are operable to predict at least one received query anticipated to be received at a search engine, and to store the at least one predictive query in association with a score threshold, as described. After receiving a stream of documents over time, in conjunction with receipt of the stream of documents at the search engine, the systems 100, 300 may index the documents and perform a comparison of each document to the at least one predictive query, using the index. After assigning a score to each comparison, the comparisons may be ranked based on each score, and comparisons may be selected from the ranked comparisons having scores above the score threshold. Then, the selected comparisons may be stored within the predictive cache 126, 126a, 126b. Each selected comparison may be associated with a score of the selected comparison, the corresponding compared document, and the at least one predictive query. Then, later, when the at least one received query is received at the search engine, the search engine may provide at least one document of the selected comparisons from the predictive cache.

As described above, then, the systems 100 and 300, and similar systems, provide search systems which are effectively pre-populated with predictive search results that represent detailed knowledge in a specific field or with respect to specific sets of queries. The systems 100, 300 are not required to alert recipients to the presence of such documents, nor to publish the results to any user. Instead, the systems 100, 300 maintain one or more predictive caches which are thus always fresh for the predictive queries, including, e.g., the most popular or most frequent queries typically received or predicted to be received by a related search engine. The predictive queries are stored over time and may be matched against new documents as the new documents arrive, so that new predictive search results are essentially instantly available up receipt of a corresponding query.

FIG. 5 is a block diagram showing example or representative computing devices and associated elements that may be used to implement the systems of FIGS. 1 and 3. FIG. 5 shows an example of a generic computer device 500 and a generic mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552, that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smart phone 582, personal digital assistant, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

What is claimed is:

1. A computer system including instructions stored on a computer-readable medium, the computer system comprising:
a query manager configured to manage a query corpus including at least one predictive query;
a document manager configured to receive a plurality of documents from at least one document source, and to manage a document corpus including at least one document obtained from the at least one document source;
a predictive result manager configured to associate the at least one document with the at least one predictive query to obtain a predictive search result, and configured to update a predictive cache using the predictive search result; and
a search engine configured to access the predictive cache to associate a received query with the predictive search result, and configured to provide the predictive search result as a search result of the received query, the search result including the at least one document.

2. The system of claim 1, wherein the query manager comprises a query collector configured to obtain the at least one predictive query using a query log of previous queries received at the search engine.

3. The system of claim 1, wherein the query manager comprises a query predictor configured to predict the at least one predictive query based on pre-determined prediction criteria.

4. The system of claim 1, wherein the query manager comprises a query predictor configured to analyze a content of received documents from the document source over time, and to predict the at least one predictive query adaptively over time, based thereon.

5. The system of claim 1, wherein the query manager is configured to manage a lifetime of predictive queries within the query corpus over time.

6. The system of claim 1 wherein the document manager is configured to receive a stream of documents over time, including the at least one document.

7. The system of claim 1 wherein the predictive result manager comprises an indexer configured to index the plurality of documents including the at least one document

8. The system of claim 7 wherein the predictive result manager comprises:
a matcher configured to match the at least one document against predictive queries in the query corpus, including the at least one predictive query, using the index;
a filter configured to filter out matched ones of the predictive queries which do not satisfy a filtering criteria; and
a scorer configured to assign a score to the matched, filtered predictive queries, including the at least one predictive query, the score associated with a usefulness of the scored predictive query and document pair as part of the predictive search result.

9. The system of claim 1 wherein the query manager comprises a threshold manager configured to assign a threshold to the at least one predictive query, and wherein the predictive result manager comprises a scorer configured to assign a score to the at least one predictive query relative to the at least one document, and configured to keep or discard the at least one predictive query based on a comparison of the score to the threshold.

10. The system of claim 9 wherein the predictive result manager provides the predictive search result including a tuple that includes the at least one document, the at least one predictive query, and the score.

11. The system of claim 10 wherein the predictive result manager initially provides the predictive search result including the at least one document associated with a plurality of predictive queries including the at least one predictive query, and wherein the predictive result manager comprises an inverter configured to store the predictive search result in the predictive cache including the at least one predictive query related to a plurality of documents including the at least one document.

12. The system of claim 9 wherein the threshold manager is configured to assign the threshold based on an analysis of an extent of matching of the at least one predictive query to documents of the plurality of documents.

13. The system of claim 12 wherein the threshold manager is configured to dynamically adjust the threshold based on a detected change in the extent of matching.

14. The system of claim 1 wherein the predictive result manager comprises a cache selector configured to update a plurality of predictive caches, each predictive cache associated with a corresponding query set of the query corpus.

15. The system of claim 1 wherein the predictive result manager comprises an index selector configured to select an index from a plurality of indices to perform indexing of a plurality of documents from the document source, including the at least one document.

16. The system of claim 1 wherein the predictive result manager comprises a server selector configured to associate the predictive search result with one of a plurality of search servers.

17. The system of claim 1 wherein the search engine is configured to access the at least one document source to provide search results to received queries other than the receive query.

18. The system of claim 1 wherein the search engine comprises a result source selector configured to select between the predictive cache, a cache of the search engine, and an index of the search engine when providing the search result.

19. The system of claim 1 wherein the at least one predictive query includes a query that is calculated to be received at a future time.

20. A computer-implemented method in which at least one processor implements at least the following operations, the method comprising:
determining at least one document from a document corpus;
determining at least one predictive query from a query corpus;
associating the at least one document with the at least one predictive query;
storing the at least one document and the least one predictive query together as a predictive search result in a predictive cache;
receiving, after the storing, a received query;
determining the predictive search result from the predictive cache, based on the received query; and
providing the at least one document from the predictive cache.

21. The computer-implemented method of claim 20 wherein associating the at least one document with the at least one predictive query comprises assigning a score ranking a utility of the association in providing the predictive search result, relative to other associations of the at least one document with other predictive queries.

22. The computer-implemented method of claim 20 wherein the received query is received at a retrospective search engine.

23. A computer program product for handling transaction information, the computer program product being tangibly embodied on a computer-readable medium and including executable code that, when executed, is configured to cause a data processing apparatus to:
predict at least one received query anticipated to be received at a search engine;
store the at least one predictive query in association with a score threshold;
receive a stream of documents over time, in conjunction with receipt of the stream of documents at the search engine;
index the documents;
perform comparisons of documents of the stream of documents to the at least one predictive query, using the index;
assign scores to the comparisons;
rank the comparisons based on the scores;
select from the ranked comparisons selected comparisons having scores above the score threshold;
store the selected comparisons within a predictive cache in which theselected comparisons are associated with scores thereof, the corresponding compared documents, and the at least one predictive query;
receive the at least one received query at the search engine; and
provide at least one document of the selected comparisons from the predictive cache.

24. The computer program product of claim 23, wherein the score threshold is determined based on an analysis of an extent of matching of the at least one predictive query with previously-received documents of the stream of documents.

25. The computer program product of claim 23, wherein the score threshold is dynamically adjusted over time based on an analysis of a change over time of an extent of matching of the at least one predictive query with documents of the stream of documents.
